(19) United States
(12) Patent Application Publication
(10) Pub. No.: US 2016/0105895 A1
(43) Pub. Date: Apr. 14, 2016

(54) Portable Communication Device with Recording Format Transformation Module

(71) Applicant: Kuo-Ching CHIANG, New Taipei City (TW)

(72) Inventor: Kuo-Ching CHIANG, New Taipei City (TW)

(21) Appl. No.: 14/864,893

(22) Filed: Sep. 25, 2015

(30) Foreign Application Priority Data
Oct. 9, 2014 (TW) 103135321

(51) Int. Cl. H04W 72/06; G10L 13/04; H04M 3/42; G10L 15/26; H04L 12/58; H04L 29/12

(52) U.S. Cl. CPC H04W 72/06; H04L 51/12; H04L 61/1594; H04M 3/42025; G10L 15/265; G10L 13/043

(57) ABSTRACT

A hand-held communication device with a recording format transformation module includes a control unit, a display coupled to the control unit; a contact book coupled to the control unit to store a list of contact person's account information and related information thereof; and a recording format transformation module coupled to the control unit to transform recorded sound files into text files for reading or transform text files into audio files for listening.

### CROSS-REFERENCE TO RELATED APPLICATIONS

The present application claims the benefit of TAIWAN Patent Application Serial Number 103135321 filed on Oct. 9, 2014, which is herein incorporated by reference.

### TECHNICAL FIELD

The present invention relates to a portable device, and more particularly to a portable device with recording format transformation module.

### BACKGROUND OF RELATED ART

Information may be exchanged with faster speed and higher capacity due to the development of information technology. Internet is designed as an open structure in which information can be exchanged freely without limitation. A third generation mobile phone system specification allows a user to employ video communication via air. Therefore, specific communication services which need real-time information exchange, for example watching live videos, have become practicable through mobile communication network or Internet.

### SUMMARY

The present invention provides a synchronous communication system via Internet, including a local area network and a terminal device coupled to the Internet; a portable device having a dual network linking capability module which transmits information via a RF module or a wireless local area network module, wherein the portable device may include an Internet communication module and the wireless local area network module to allow a user to synchronously transmit or receive data via the Internet portably, wherein the transmitted data may be selected from audio signals, video signals or the combination thereof. The terminal device may be a computer, a PDA (personal digital assistant), a notebook, a mobile phone or a smart phone, which can employ Internet via the local area network. The system may further include a mobile communication service network. The system may also include an exchanging service mechanism to bridge the Internet and the mobile network to facilitate the communication therebetween. The system may further include a public switch telephone network (PSTN).

The present invention provides a synchronous communication system via Internet, including a central control unit, a manipulation panel, a display, an operating system and a memory coupled to the central control unit respectively; a RF module compatible to a mobile phone communication protocol; a wireless local area network module compatible to a local area network protocol; a CODEC (coder-decoder) and a analog/digital converter coupled to the wireless local area network module and the RF module; a vocal input/output unit coupled to the analog/digital converter; and an Internet communication module. The Internet communication module and the wireless local area network module can allow a user to synchronously transmit or receive data via the network connected by the wireless local area network module portably, wherein the data may be selected from the group of audio signals, video signals or the combination thereof. The wireless local area network module may include a Bluetooth specification compatible module, a Wi-Fi specification compatible module or a 802.11x specification compatible module, wherein x may be a, b or g. The wireless local area network module may be compatible to WiMAX (Worldwide Interoperability for Microwave Access) specification.

The present invention provides a portable device with a dual network linking capability module to transmit or receive data via a mobile communication service network or the Internet, wherein the portable device may include an Internet communication module and a wireless local area network module to allow a user to synchronously transmit or receive data via the local area network portably, wherein the data may be selected from audio signals, video signals or the combination thereof

A portable device for video communication includes a central control unit and a display coupled to the central control unit; a converter coupled to the central control unit; a vocal I/O unit coupled to the converter; an image capturing module coupled to the central control unit; a video communication module coupled to the central control unit to employ video communication; and an image division module coupled to the central control unit to divide the display region on the display when performing multi-party video communication and receiving multiple images from the multi-parties.

A hand-held communication device with a dynamic ranking module, including: a control unit; a display coupled to the control unit; a contact book or a contact account list including a number of contact persons or a number of contact accounts and related information thereof; a dynamic ranking module coupled to the control unit to re-arrange an order of the number of contact persons or the number of contact accounts based the usage frequency of the number of contact persons or the number of contact accounts. The hand-held communication device may further include a phone call filtering module to filter out the number of contact persons or the number of contact accounts which are listed in a black list. The phone call filtering module may further include a user interface to allow a user to input the black list. A recording format transformation module is coupled to the control unit to transform recorded sound files into text files for reading or transform text files into audio files for listening.

The hand-held communication device may further include a contextual module to provide background contextual sounds or images to transmit the background contextual sounds or images when a user performs a communication. The hand-held communication device may further include a composition module coupled to the contextual module to at least synthesize a sound of the communication and the background contextual sounds or images.

A hand-held communication device, including: a control unit; a display coupled to the control unit; a contact book or a contact account list including a number of contact persons or a number of contact accounts and related information thereof; a contextual module to provide background contextual sounds or images to transmit the background contextual sounds or images when a user performs a communication. The hand-held communication device may further include a phone call filtering module to filter out the number of contact persons or the number of contact accounts which are listed in a black list. The phone call filtering module may further include a user interface to allow a user to input the black list. The hand-held communication device may further include a composition module coupled to the contextual module to at least synthesize a sound of the communication and the background contextual sounds or images. A recording format transformation module is coupled to the control unit to transform recorded sound files into text files for reading or transform text files into audio files for listening.

### BRIEF DESCRIPTION OF THE DRAWINGS

The aforementioned aspects and the advantages of the present invention may be readily understood by the following detailed descriptions, and the spirit of the present invention may be easily understood by the descriptions and the attached drawings below, wherein:

FIG. 1 illustrates a block diagram of a device of the present invention;

FIG. 2 illustrates a block diagram of a device of the present invention in accordance with one embodiment;

FIG. 3 illustrates a block diagram of a device of the present invention in accordance with one embodiment;

FIGS. 4A and 4B illustrate a block diagram of a device of the present invention in accordance with one embodiment; and

FIG. 5 illustrates a block diagram of a device of the present invention in accordance with one embodiment.

### DETAILED DESCRIPTION

In the following descriptions, various specific details are provided for comprehensive understanding of the embodiments of the present invention. The present invention will now be described in detail with the preferred embodiments and the attached drawings, and it should be comprehended that all of the preferred embodiments of the present invention are provided only for illustrating but not for limiting the Claims of the present invention. It should also be understood by the person having ordinary skill in the art that the present invention may be performed without one or more specific details or other specific methods.

At least two different communication networks and protocols, for instance W-CDMA, CDMA2000, CDMA2001, TD-CDMA, TD-SCDMA, UWC-136, DECT, fourth generation(4G) communication service network, etc, may be included in a communication system and environment. A local area network may be coupled to Internet. For example, a mobile terminal device of a user may be coupled to a mobile network. Similarly, a computer may be coupled to Internet. In one embodiment, a computer may be coupled to Internet via an access point (AP). It should be noted that the number of the terminal devices may be changed, and the present invention will cover any possible number of terminal devices. These devices may include, but be not limited to, PDA (personal digital assistant), tablet PC, notebook and mobile phone or smart phone. All of these devices can access Internet. Information exchange among these devices may be performed directly through Internet.

The terminal devices may be located in different networks such as Internet and mobile network. An exchange service mechanism bridges at least two different networks described above to perform communication between the terminal devices in the two networks. In other words, the exchange service mechanism can relay and connect service between systems or networks, which is well-known by the person having ordinary skill in the art. Access points (or hot spots) may be coupled to Internet to provide an entrance to the local area network for wireless communication. One aspect of the present invention is that the system includes a portable device with dual network function. The device can transmit or receive data through mobile network or Internet. The transmitted or received data may include audio, video, or audio and video.

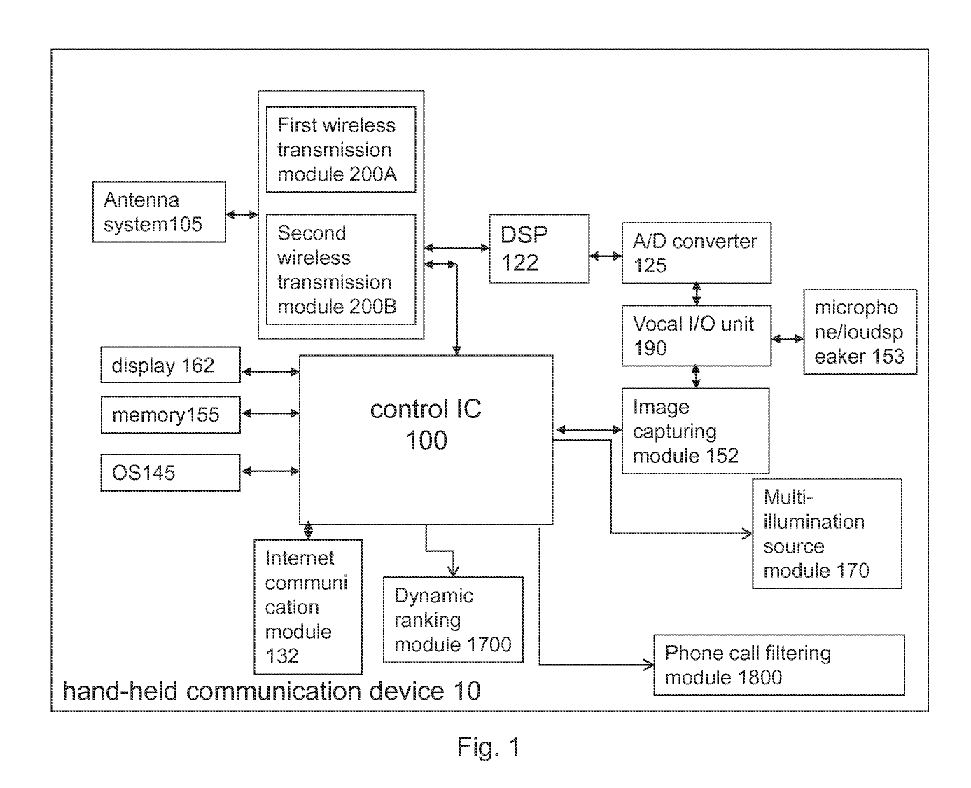

Please refer to FIG. 1, which illustrates a functional diagram of a portable device 10 with dual network function. A dual way portable terminal device 10 may have a SIM (subscriber identity module) card connector that can support SIM card, which is a conventional technology. In other kinds of mobile phones such as PHS or some CDMA systems, the SIM card is unnecessary. This figure is provided for illustrating, but not for limiting the claims of the present invention. The portable terminal device or the device 10 may include a first wireless data transmission module 200A and a second wireless data transmission module 200B. The first wireless data transmission module 200A may be a video RF (radio frequency) module to transmit or receive mobile signals, which is well-known by the person having ordinary skill in the art. As the conventional technology, the RF module may be coupled to an antenna system 105. The RF module may include a base band processor, etc. The antenna may be connected to a transceiver for receiving and transmitting signals. The first wireless data transmission module 200A may be compatible to various mobile protocols, such as W-CDMA, CDMA2000, CDMA2001, TD-CDMA, TD-SCDMA, UWC0136, DECT, 4G systems. These systems allow a user to utilize video communication to communicate with others. The RF module can perform functions such as the transmission and reception of signals, the synchronization of frequency, baseband processing and digital signal processing. The hardware interface of the SIM card connector is employed to receive a SIM card. Finally, the signals are transmitted to final actuators, i.e. a vocal input/output unit 190, which includes a loudspeaker and a microphone 153. The first wireless data transmission module 200A and the second wireless data transmission module 200B may be formed from individual modules (chips) or an integrated chip.

The device 10 may also include a digital signal processor 122, a CODEC (not shown) and an analog/digital (A/D) converter 125. The present invention includes a central control unit 100, a display 162, an operating system (OS) 145 and a memory 155. The memory 155 may include a ROM, a RAM and a non-volatile flash memory. The aforementioned units are coupled to the central control unit 100 respectively. A wired input/output interface may be coupled to the central control unit 100. The wired input/output interface may be USB (universal serial bus) or IEEE1394.

The device 10 may further include a second wireless data transmission module 200B. In one embodiment, the second wireless data transmission module 200B may employ a wireless short-distance (local) network module and may be compatible to a local or metropolitan area network protocol or other specifications, such as Wi-Fi specification or 802.11x (x means a, b, g, n) specification compatible modules. The short distance means that the communication distance thereof is shorter than that of the mobile communication signals.

Furthermore, the wireless local area network module may be compatible to WIMAX specification or standard. An Internet communication module (software) 132 may be coupled to the central control unit 100 to transmit audio, video or audio and video to Internet, or receive audio, video or audio and video from Internet via the wireless local area network module. The Internet communication module 132 may at least comply with VoIP (voice over internet protocol) specification. Through the Internet communication module 132 and the wireless local area network module 200B, the user can employ the Internet communication module 132 to synchronously transmit and receive audio, video or audio and video via Internet anytime and anywhere. If the user would like to implement real-time video transmission, an image capturing module 152 may be needed to be coupled to the central control unit 100, so as to capture videos and images. The image capturing module 152 may be a digital camera or digital video recorder. Therefore, a real time portable conference may be held anytime and anywhere. In another embodiment, the difference is that the RF module may be omitted in the device. If the device 10 includes a 3G module or a higher level RF module, the user can transmit video phone calls via air. Thus, the user can choose Internet or air to perform video phone calls depending upon his/her demands. If the device is located in hot spot area, the user can choose the Internet communication module to perform communication because the transmission rate of Internet phone calls is cheaper. If he/she is located outside the hot spot area, other choice may be provided to perform video communication. Generally, WCDMA signal is not limited to geography, but its transmission rate is higher. The present invention allows the user to choose a proper wireless module, so as to perform video communication. If the user would like to implement video communication via Wi-Fi or WiMax, the method includes coupling to Internet or a hot spot, and then enabling Internet communication module (software). Subsequently, audio signals are input by the microphone while the image data are captured by the image capturing device. Then, the image data and the audio signals are converted into digital signals from analog signals. After the conversion, the image data and the audio signals are combined, compressed and processed to form a data stream. Thus, the data can be actually transmitted to the receiving party. When transmitting digital music and video, it is considered to be desirable that the output of a channel decoder has a bit error rate (BER) of less than about 10⁻⁵. The influence of a bit in a specific source coded bit stream (for example a compressed audio, image or video bit stream) on the quality of the reconstructed signals usually has different levels of importance. Therefore, it is usually desirable that different levels of channel error protection are provided for different segments of source code bit stream. The technique of employing different channel coding to provide unequal error protection is described in U.S. patent application Ser. No. 09/022,144 entitled “Unequal Error Protection for Perceptual Audio Coders” filed on Feb. 11, 1998. A source code bit stream is divided into different classes of bits, so as to provide different levels of error protection for different classes of bits.

A single or multi-illumination source module 170 may be coupled to the control unit 100 to perform video communication in a dark or low-light level environment. Thus, a photo sensor may be coupled to a switch coupled with the multi-illumination source module. When the intensity of the light is smaller than a predetermined level, the control unit will actuate the illumination in response to the signal detected by the photo sensor, so as to provide the light required for video communication or photographing. One mode of the illumination source may be a night vision mode such as an infrared (IR) mode, so as to support the video communication mode or the video capturing mode in a dark environment. Another mode of the illumination source may be a flashing mode, so as to provide a flashing light when photographing at a low light intensity. The user can choose the mode via a mode selector coupled to the switch. The illumination module may include an infrared device and a light emitting diode (LED) emitting white light. Moreover, the illumination module may include a xenon illumination device. A gas is provided to a discharge region during a charged particle generation period to replace most of the air therein. The gas is a combined gas which mainly includes nitrogen and has specific amounts of argon, neon, xenon or krypton to provide a catalyst for ionizing nitrogen. The user can choose a proper illumination device depending upon different situations and different purposes. Especially, the present invention can implement video communication in a dark environment.

The device may be coupled to Internet and upload or download data including digital data such as text, image, audio or video through the wired input/output interface or the wireless local area network (WLAN) module 200B. The wired input/output interface may be coupled to the central control unit 100. The application of the device is very economic and convenient. Furthermore, when the wireless local area network module detects the signal of Internet, the user can call someone else via the Internet communication module to save the transmission rate. Otherwise, the user can utilize WCDMA to perform video communication. A real time video conference can be held anytime and anywhere through the present invention. Further, the present invention synchronously provides a dual mode (3G or Internet video phone) portable audio/video communication.

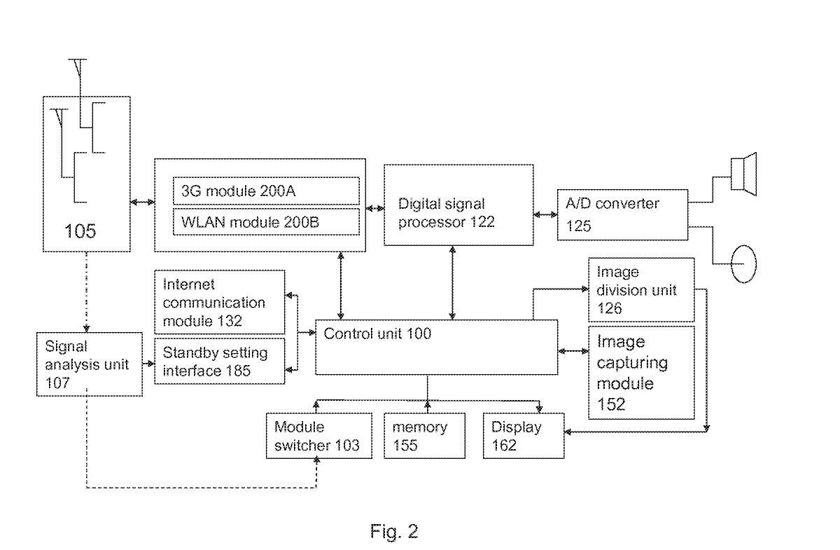

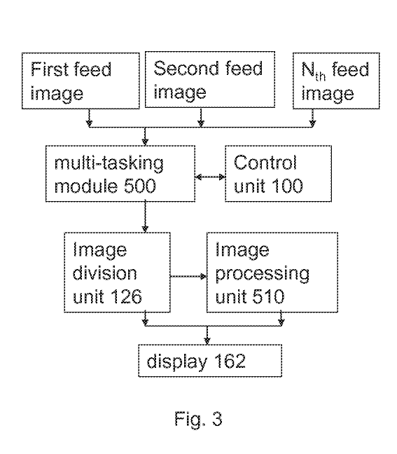

FIG. 2 illustrates another embodiment of the present invention. Almost all of the elements are the same as those in FIG. 1, and therefore the detailed description thereof is omitted. A signal analysis unit 107 is provided to analyze the intensity of the signal of the dual communication module, i.e. the first wireless transmission module 200A and the second wireless transmission module 200B. The analysis result is provided to a module switcher 103 to automatically switch the module or manually set the module through a standby setting interface 185. In order to implant multi-party video communication, the device 10 may include an image division unit 126 coupled to the control unit 100 to synchronously divide the display regions on the display and display the received image. The received image is assigned to the divided display regions on the display. The display regions may be independent, separated, overlapped or partially overlapped. Please refer to FIG. 3. A plurality of incoming images are transmitted to a multi-tasking module 500 to process the images received from multiple parties. Before transmitting the image data signals to the display 162, the images are processed by the image division unit 126. An image processing unit 510 may be employed to adjust and process the images before displaying them.

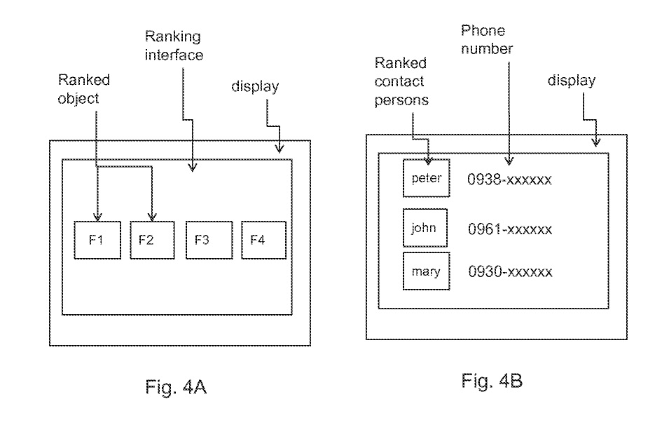

The present invention may further include a dynamic ranking module 1700 coupled to the control unit to analyze the contact persons who communicate with the user most frequently, for example the most frequently contacted persons, the most frequently emailed person, the most frequently real time chatted person; or the most frequently surfed web, blog or facebook. The dynamic ranking module 1700 re-arranges the contact information, the web addresses or the accounts based on the usage frequency during a period; the usage period may be based on hours, days, weeks, months or seasons, and a selection interface may be provided in order for the user to choose. Thus, the dynamic ranking module 1700 re-arranges the accounts or the contact persons by calculating or compiling statistics on the most frequently contacted or used information during the period via the dynamic ranking module 1700 itself or additional counters. The re-arrangement is based on the usage frequency or the usage times to allow high ranking contact person to be listed on a top or a first page of a user interface displayed on the display, and is automatically and mobilely performed based on the frequency. For instance, if the contact information is a contact book, the re-arrangement is based on the usage frequency, not only based upon the stroke or the alphabetical order. Traditionally, the contact information is arranged only according to the stroke or the alphabetical order, resulting in that frequently used alphabets or the surnames or names with a large number of strokes are arranged at the last page while the rarely used information is arranged at the beginning page, and the user must scroll to the last page to obtain the contact information, which is very inconvenient. The present invention utilizes the dynamic ranking module to arrange the most frequently used contact persons to the beginning pages. Please refer to FIGS. 4A and 4B. The dynamic ranking module 1700 dynamically re-arranges the contact persons and the related information thereof based on the usage frequency. The hand-held communication device may also include a phone call filtering module 1800 coupled to the control unit; the phone call filtering module 1800 may include a user interface displayed on the display to allow the user to input a black list of person and corresponding contact information or accounts. When a phone call or a communication comes from a contact person who is listed in the black list, the phone call filtering module 1800 checks whether the contact person is in the black list or not. If yes, the phone call filtering module 1800 directs it into a voice mail or hangs up the phone directly. Moreover, the phone call filtering module 1800 may generate a time limitation interface in order for the user to input duration for the black list. After the duration passes, the black list is automatically removed.

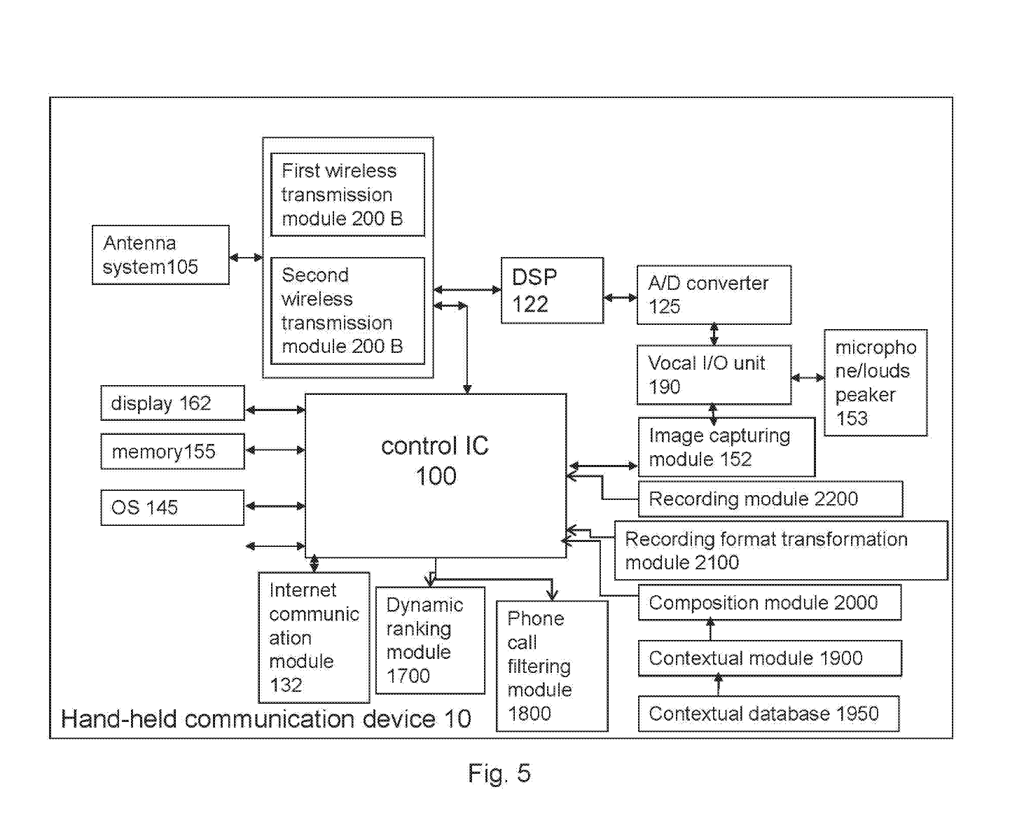

Furthermore, please refer to FIG. 5, in which most of the elements are similar to those in FIG. 1, and therefore the detailed descriptions of the overlapped elements are omitted. The present invention may further include a contextual module 1900. The contextual module 1900 may include a contextual database 1950, which includes many preset background sounds or images, such as background sounds or images of different situations, for instance stations, airports, streets, entertainment facilities, hospitals, markets, malls, piers, stadiums, offices, conference rooms, factories, etc. The aforementioned facilities are described for illustrating the present invention, but not for limiting the present invention. When the contextual module 1900 is enabled, a user interface may be displayed in order for the user to choose one situation. Then, the chosen situation is synthesized with the sounds inputted by the microphone or the images captured by the image capturing device, so as to be subsequently transmitted to the other party via the transmission device. Therefore, the present invention may include a composition module 2000 to receive the contextual information transmitted from the contextual module 1900 and the sounds inputted by the microphone or/and the images captured by the image capturing device and synthesize them. The contextual module 1900 and the composition module 2000 may be independent modules or an integrated system or module. Similarly, the dynamic ranking module 1700, the phone call filtering module 1800 and the contextual module 1900 may be independent modules or an integrated system or module. AND GATE circuitry may be utilized to design the composition module 2000. When a call comes from a person whom the user would not like to contact with, noise or hospital background sounds may be inputted, so as to hang up the phone; similarly, different background information may be provided to the user, such that the user can refuse the calls or render the caller not to know where the user is.

Moreover, please refer to FIG. 5, in which most of the elements are similar to those in FIG. 1, and therefore the detailed descriptions of the overlapped elements are omitted. The present invention may also include a recording format transformation module 2100 coupled with the control unit to transform the recording format. For instance, the recorded sound files may be transformed into text files, or text files may be transformed into audio files to meet the need of the consumers. For example, the voice record generated in a conference room or the recorded sound files during telephone currency may be transformed into text file format afterwards for reading; or text files may be transformed into sound format for listening depending on the need of the user. The present invention may further include a recording module 2200 coupled with the control unit to record the sound.

The present invention is described above with the preferred embodiments. However, it should be appreciated that this embodiment is described not for limiting the Claims of the present invention. Numerous alterations and modifications may be practiced by those skilled in the art without departing from the spirit and scope of the present invention. It is intended that all such modifications and alterations are included insofar as they come within the scope of the present invention as claimed or the equivalents thereof.

What is claimed is:

1. A hand-held communication device with a recording format transformation module, comprising:
a control unit;
a display coupled to said control unit;
a contact book or a contact account list including a number of contact persons or a number of contact accounts and related information thereof; and
a recording format transformation module coupled to said control unit to transform recorded sound files into text files for reading or transform text files into audio files for listening.

2. The hand-held communication device of claim 1, further comprising a phone call filtering module to filter out said number of contact persons or said number of contact accounts which are listed in a black list.

3. The hand-held communication device of claim 2, wherein said phone call filtering module further comprises a user interface to allow a user to input said black list.

4. The hand-held communication device of claim 3, wherein said phone call filtering module further comprises a user interface to allow a user to input duration for said black list.

5. The hand-held communication device of claim 2, further comprising a dynamic ranking module coupled to said control unit to re-arrange an order of said number of contact persons or said number of contact accounts based a usage frequency of said number of contact persons or said number of contact accounts.

6. The hand-held communication device of claim 2, further comprising a contextual module to provide background contextual sounds or images to transmit said background contextual sounds or images when a user performs a communication.

7. The hand-held communication device of claim 1, further comprising a dynamic ranking module coupled to said control unit to re-arrange an order of said number of contact persons or said number of contact accounts based a usage frequency of said number of contact persons or said number of contact accounts.

8. The hand-held communication device of claim 1, further comprising a contextual module to provide background contextual sounds or images to transmit said background contextual sounds or images when a user performs a communication.

9. The hand-held communication device of claim 8, further comprising a composition module coupled to said contextual module to at least synthesize a sound of said communication and said background contextual sounds or images.

10. A hand-held communication device with a contextual module, comprising:
a control unit;
a display coupled to said control unit;
a contact book or a contact account list including a number of contact persons or a number of contact accounts and related information thereof;
a recording module coupled to said control unit to record sounds; and
a recording format transformation module coupled to said control unit to transform recorded sound files into text files for reading or transform text files into audio files for listening.

11. The hand-held communication device of claim 10, further comprising a phone call filtering module to filter out said number of contact persons or said number of contact accounts which are listed in a black list.

12. The hand-held communication device of claim 11, wherein said phone call filtering module further comprises a user interface to allow a user to input said black list.

13. The hand-held communication device of claim 11, further comprising a contextual module to provide background contextual sounds or images to transmit said background contextual sounds or images when a user perform a communication.

14. The hand-held communication device of claim 10, further comprising a contextual module to provide background contextual sounds or images to transmit said background contextual sounds or images when a user perform a communication.

15. The hand-held communication device of claim 14, further comprising a composition module coupled to said contextual module to at least synthesize a sound of said communication and said background contextual sounds or images.
